(19) United States
(12) Patent Application Publication
(10) Pub. No.: US 2025/0052891 A1
(43) Pub. Date: Feb. 13, 2025

(54) DETECTION APPARATUS, DETECTION METHOD, AND NON-TRANSITORY STORAGE MEDIUM

(71) Applicant: NEC Corporation, Minato-ku, Tokyo (JP)

(72) Inventors: Nagma Samreen Khan, Tokyo (JP); Kazumine Ogura, Tokyo (JP); Tatsuya Sumiya, Tokyo (JP); Masayuki Ariyoshi, Tokyo (JP)

(73) Assignee: NEC Corporation, Minato-ku, Tokyo (JP)

(21) Appl. No.: 18/722,936

(22) PCT Filed: Jan. 5, 2022
(86) PCT No.: PCT/JP2022/000084

§ 371 Date: Jun. 21, 2024

(51) Int. Cl. G01S 13/88; G01S 13/89; G06T 7/62; G06T 7/70; G06V 10/764

(52) U.S. Cl. CPC G01S 13/887; G01S 13/89; G06T 7/62; G06T 7/70; G06V 10/764; G06V 2201/05; G06V 2201/07

(57) ABSTRACT

The detection apparatus (100) of the first example embodiment includes a position determination unit (12), an extraction unit (14), a model selection unit (16), and a detection unit (18). The position determination unit (12) determines a position of a subject in a 3D radar image. The extraction unit (14) extracts a 3D sub-image from the 3D radar image by using a reference position based on the determined position of the subject and one of extraction sizes specified for each type of subject. The model selection unit (16) selects at least a learned model based on at least one of a size of the 3D sub-image and a type of the subject included in the 3D radar image. The detection unit (18) which detects an object in the 3D sub-image by using the selected learned model.

### TECHNICAL FIELD

The present invention relates to an object detection system for radar images, where the scattered radio waves by a moving target object is measured, then imaging is performed which generates a 3D radar image of the target under scan. The said 3D image is used by a deep learning module to detect i.e. check for presence/absence of concealed dangerous objects.

An example of a conventional object detection system for radar images is described in Non-Patent Literature 1. This conventional object detection system includes radar signal measurement means, image generation means, and object detection means. Specifically, the measurement means includes the radar antennas which transmit the radar waves and receive the reflected scattered waves. Also, the generated 3D radar image is projected to 2D and utilized by a deep learning module to detect the presence or absence of an object of interest in the radar image. In the Non-Patent Literature 1, the object detection system for radar images is used for concealed weapon detection.

Patent Literature 1 discloses that an image processing area for extracting an image portion of a monitoring object is set according to a type of the monitoring object.

Patent Literature 2 discloses that a part of an image based on the result of a preliminary inspection is used for determining whether or not the target person possesses a prohibited object. Also, Patent Literature 2 discloses that as an example of a judgment method based on the shape of an object appearing in a transparent image, the use of machine learning can be considered.

### CITATION LIST

### Patent Literature

[Patent Literature 1] International Publication WO2008/139529A1
[Patent Literature 2] International Publication WO2021/166150A1

### Non-Patent Literature

[Non-Patent Literature 1] L. Carrer, “Concealed Weapon Detection: A microwave imaging approach”, Master of Science Thesis, Delft University of Technology, 2012

### SUMMARY OF INVENTION

### Technical Problem

However, by the technique of Non-Patent Literature 1, it takes a long time to detect objects. The technique of Patent Literature 1 could not be applied to the use of learned models by machine Learning. Also, Patent Literature 2 does not disclose a technique for reducing processing time of the determination unit using a learned model without compromising its performance.

An example of objective of the present invention is to reduce processing time for detecting objects without compromising detection accuracy, when a learned model is used for the detection.

### Solution to Problem

The present invention provides a detection apparatus comprising:
a position determination unit that determines a position of a subject in a 3D radar image:
an extraction unit that extracts a 3D sub-image from the 3D radar image by using a reference position based on the determined position of the subject and one of extraction sizes specified for each type of subject;
a model selection unit that selects at least a learned model based on at least one of a size of the 3D sub-image and a type of the subject included in the 3D radar image; and
a detection unit that detects an object in the 3D sub-image by using the selected learned model.

The present invention provides a model generation apparatus comprising:
a position determination unit which determines a position of a subject in a 3D radar image;
an extraction unit which extracts a 3D sub-image from the 3D radar image by using a reference position based on the determined position of the subject and one of extraction sizes specified for each type of subject;
a model selection unit which selects at least a model based on at least one of a size of the 3D sub-image and a type of the subject included in the 3D radar image; and
a training unit which performs machine learning on the selected model by using a combination of the 3D sub-image and information indicating a position of the object in the 3D sub-image as training data.

The present invention provides a detection method, performed by a computer, comprising:
determining a position of a subject in a 3D radar image;
extracting a 3D sub-image from the 3D radar image by using a reference position based on the determined position of the subject and one of extraction sizes specified for each type of subject;
selecting at least a learned model based on at least one of a size of the 3D sub-image and a type of the subject included in the 3D radar image; and
detecting an object in the 3D sub-image by using the selected learned model.

The present invention provides a program causing a computer to execute a detection method, the detection method comprising:
determining a position of a subject in a 3D radar image;
extracting a 3D sub-image from the 3D radar image by using a reference position based on the determined position of the subject and one of extraction sizes specified for each type of subject;
selecting at least a learned model based on at least one of a size of the 3D sub-image and a type of the subject included in the 3D radar image; and
detecting an object in the 3D sub-image by using the selected learned model.

### Advantageous Effects of Invention

The aim of the present invention is to reduce processing time for detecting objects without compromising detection accuracy, when a learned model is used for the detection.

### BRIEF DESCRIPTION OF DRAWINGS

FIG. 1 is a figure to explain setup of the radar image measurement system and also explain the relative positions of the target with respect to the radar.

FIG. 2 is a block diagram illustrating a function-based configuration of the detection apparatus according to the first example embodiment.

FIG. 3 is a block diagram illustrating a hardware configuration of a computer realizing the detection apparatus according to the first example embodiment.

FIG. 4 is a flowchart illustrating a flow of processes performed by the detection apparatus of the first example embodiment.

FIG. 5 is a block diagram illustrating the function-based example configuration of the detection apparatus according to the first example embodiment.

FIG. 6 is a figure shows an example table of the subject DB of the detection apparatus according to the first example embodiment.

FIG. 7 is a figure shows an example configuration of the network architecture DB of the detection apparatus according to the first example embodiment.

FIG. 8 is a block diagram illustrating the function-based configuration of the detection apparatus including the subject finder of the first example.

FIG. 9 is a figure shows the graphic representation of the example operation of the detection apparatus according to the first example embodiment.

FIG. 10 is an block diagram illustrating the function-based configuration of the detection apparatus including the subject finder of the second example.

FIG. 11 is a block diagram illustrating the function-based configuration of the detection apparatus including the subject finder of the third example.

FIG. 12 is a figure shows another example table of the subject DB of the detection apparatus according to the first example embodiment.

FIG. 13 is a flowchart illustrating the operation of the detection apparatus according to the first example embodiment.

FIG. 14 is a block diagram illustrating a function-based configuration of the model generation apparatus according to the second example embodiment.

FIG. 15 is a flowchart illustrating a flow of processes performed by the model generation apparatus according to the second example embodiment.

FIG. 16 is a block diagram illustrating the function-based example configuration of the model generation apparatus according to the second example embodiment.

FIG. 17 is a flowchart illustrating the operation of the model generation apparatus according to the second example embodiment.

FIG. 18 is a block diagram illustrating the function-based example configuration of the detection apparatus according to the third embodiment.

FIG. 19 is a flowchart illustrating the operation of the detection apparatus according to the third embodiment.

### DESCRIPTION OF EMBODIMENT

Embodiments of the present disclosure are explained in detail with reference to the drawings. The same components are denoted by the same symbols throughout the drawings, and duplicated explanations are not repeated for clarifying the explanations.

### First Example Embodiment

### Overview

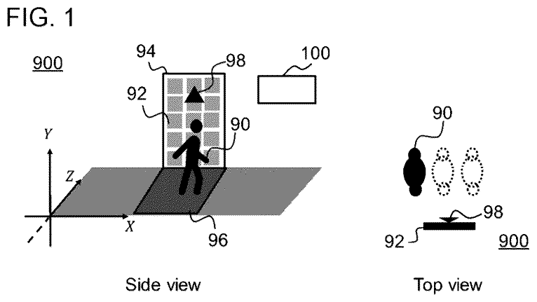

Firstly, the setup of the object detection system 900 for radar images is explained with reference to FIG. 1.

The object detection system 900 for radar images operates as follows. Firstly, the measurement of the radar signal is done. In the measurement step, the radar antenna transmit the radar signal one-by-one in specific order and the reflected waves is received by the antenna receivers. The measured radar signal is used by the image generation means to make a 3D radar image by utilizing the radar antenna information.

The specific aim of this system is to check whether a person (target) 90 possesses any concealed dangerous object or not. The system 900 measures the target 90, when it is walking in the screening area (area) 96, by the fixed antenna put in side panel 94 (radar 92). The transmitters in the antenna one-by-one transmit signal and then the received scattered signal is acquired. The system 900 also acquires a camera image using a camera (camera 98) at the same time as the radar signal. However, the system 900 according to the present example embodiment may not include a camera. The radar signal is processed using antenna information to generate a radar image which is 3D in nature. If a concealed dangerous object is possessed by the person (target 90) then it is visible in the radar image. The radar image is thus used for concealed dangerous object detection. To detect the presence of dangerous object in the radar image, a learned model by machine learning is utilized. The learned model may be included in a deep learning module. As it is understandable, we expect our entire setup to function in real-time as we expect to obtain presence/absence information of the concealed object while the target 90 is still in vicinity: But processing by the learned model is a bottleneck in general. Since the input image to the learned model is 3D in nature so large processing time is expected due to increased computational complexity of 3D. Few existing ways to reduce processing time can be resizing the 3D image to a smaller size simply by scaling or down-sampling or projecting 3D image to 2D, as suggested in background art. But it is not a good way as this would also affect the performance of the learned model due to loss of information.

As described above, the detection unit by using the learned model is required to function in real-time since our target is moving as a preferred form and we aim to detect dangerous object while target 90 is still in vicinity of the detection system 900. As mentioned, the input image to the learned model is 3D in nature and it is challenging to obtain the prediction in real-time due to higher computational complexity of 3D. By the detection apparatus 100 of the present example embodiment, it is possible to reduce processing time of the learned model without compromising its performance for radar images. This is achieved by using the extracted subject's 3D radar image (3D sub-image) as input to the learned model instead of original 3D image. The extracted subject's 3D image has reduced size but same information compared to original 3D radar image. The learned model's processing time, especially for 3D, is sensitive to input size and thus reduction in processing time. In particular, the present disclosure relates to a subject extraction system for 3D radar images which reduces processing of the learned model by reducing input image size without affecting the performance, the object detection system 900 for radar images preferably can function in real-time.

It is to be noted that the subject refers to the target and the object refers to the object-of-interest whose presence/absence information we are interested in. The object may be part of but need not be same as subject.

### <Example of Function-Based Configuration>

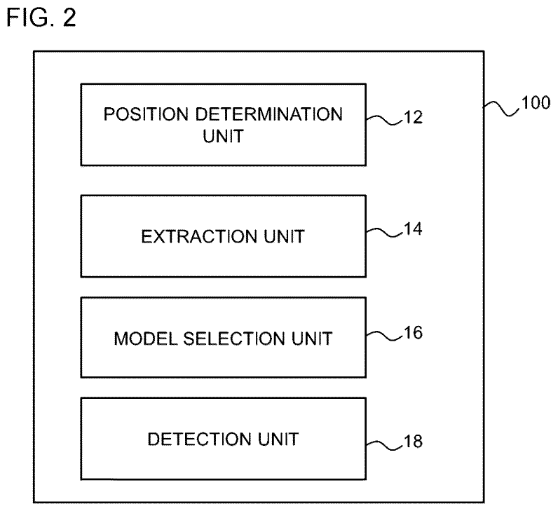

FIG. 2 illustrates an example diagram of a function-based configuration of the detection apparatus 100 according to the first example embodiment. The detection apparatus 100 of the first example embodiment includes a position determination unit 12, an extraction unit 14, a model selection unit 16, and a detection unit 18. The position determination unit 12 determines a position of a subject in a 3D radar image. The extraction unit 14 extracts a 3D sub-image from the 3D radar image by using a reference position based on the determined position of the subject and one of extraction sizes specified for each type of subject. The model selection unit 16 selects at least a learned model based on at least one of a size of the 3D sub-image and a type of the subject included in the 3D radar image. The detection unit 18 which detects an object in the 3D sub-image by using the selected learned model. The following is a detailed explanation.

The detection apparatus 100 of the present example embodiment may be included in the object detection system 900. The examples of the object include a dangerous object (knife, Gun, or the like) possessed by the target 90.

Firstly, the acquisition of the radar image will be explained with reference to FIG. 1. It is assumed that the person (target 90) is walking in the screening area 96, in front of the fixed radar antenna put in a side panel 94 (radar 92). When in screening area the target may be also in the field of view of a camera 98, which captures an image synchronized with the radar sensor. The measured scattered radar signal is sent for imaging. The generated radar image is 3D in nature. The 3D radar image is generated from the measured scattered radar signal. The 3D radar image may be generated in the detection apparatus 100 or in another device. The generated 3D radar image is stored in radar image data base (DB). The radar image DB is realized by one or more storages. The radar image DB may or may not be included in the detection apparatus 100.

The generated radar image is used to detect whether the target possesses any dangerous object or not. The detection unit 18 detects the object from a 3D image by using a learned model. The learned model may include a deep learning network. To obtain prediction from the deep learning network in short time, preferably in real-time, the extracting unit extracts image(s) of smaller size which is given as input to find object presence. The detection apparatus 100 is also referred to as the subject extraction apparatus.

Here subject refers to any whole or part of target whose image to be extracted and object refers to the dangerous object, for example. The said subject is the subject of our image i.e. which occupies the maximal area/volume in the image, examples can be living body such as human, or moving body such as car, etc. Without loss of generality; there can be more than one subject present.

In the present example embodiment, it is assumed that the subject identity is known to the detection apparatus 100 as prior information. For example, the 3D radar image is stored in the radar image DB in the state associated with a subject ID. The subject ID indicates, for example, the type of the subject such as adult, child, and senior. Also, the subject ID may indicate the type of vehicle or car model. The subject ID of each image is identified by other means such as a sensor which detects the features of the target 90 or a camera which captures the target 90 before it is stored in the radar image DB.

### <Example of Hardware Configuration>

In some embodiments, each functional unit included in the detection apparatus 100 may be implemented with at least one hardware component, and each hardware component may realize one or more of the functional units. In some embodiments, each functional unit may be implemented with at least one software component. In some embodiments, each functional unit may be implemented with a combination of hardware components and software components.

The detection apparatus 100 may be implemented with a special purpose computer manufactured for implementing the detection apparatus 100, or may be implemented with a commodity computer like a personal computer (PC), a server machine, or a mobile device.

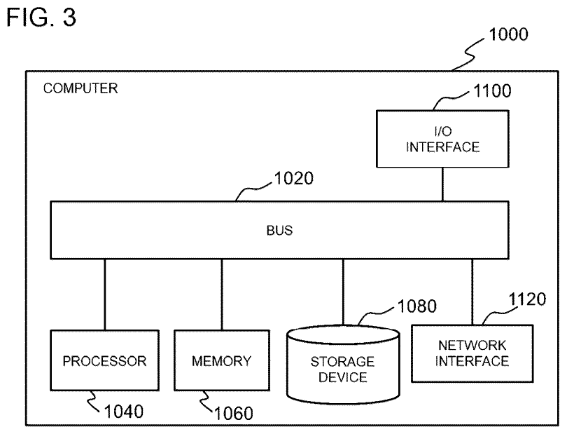

FIG. 3 is a block diagram illustrating an example of hardware configuration of a computer 1000 realizing the detection apparatus 100 of the first example embodiment. In FIG. 3, the computer 1000 includes a bus 1020, a processor 1040, a memory 1060, a storage device 1080, an input-output (I/O) interface 1100, and a network interface 1120.

The bus 1020 is a data transmission channel in order for the processor 1040, the memory 1060 and the storage device 1080 to mutually transmit and receive data. The processor 1040 is a processor such as CPU (Central Processing Unit), GPU (Graphics Processing Unit), or FPGA (Field-Programmable Gate Array). The memory 1060 is a primary storage device such as RAM (Random Access Memory). The storage medium 1080 is a secondary storage device such as hard disk drive, SSD (Solid State Drive), or ROM (Read Only Memory).

The I/O interface is an interface between the computer 1000 and peripheral devices, such as keyboard, mouse, or display device. The network interface is an interface between the computer 1000 and a communication line through which the computer 1000 communicates with another computer.

The storage device 1080 may store program modules, each of which is an implementation of a functional unit of the detection apparatus 100. The CPU 1040 executes each program module, and thereby realizing each functional unit of the detection apparatus 100.

### <Flow of Process>

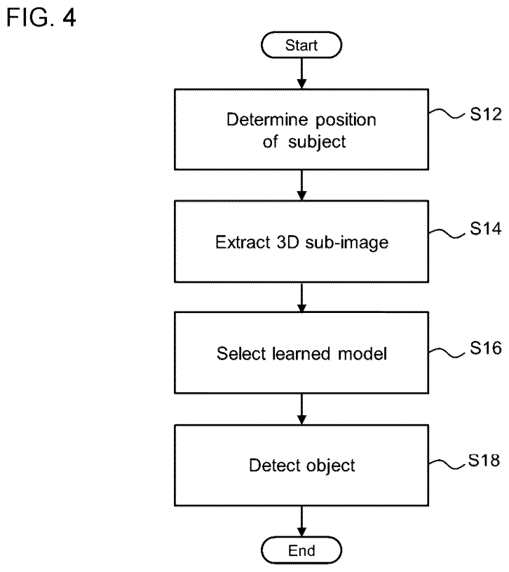

FIG. 4 is a flowchart that illustrates the process sequence performed by the detection apparatus 100 of the first example embodiment.

The detection method according to the first example embodiment is performed by a computer. The detection method includes a position determination step (S12), an extraction step (S14), a model selection step (S16), and a detection step (S18). In the position determination step, the position determination unit 12 determines a position of a subject in a 3D radar image. In the extraction step, the extraction unit 14 extracts a 3D sub-image from the 3D radar image by using a reference position based on the determined position of the subject and one of extraction sizes specified for each type of subject. In the model selection step, the model selection unit 16 selects at least a learned model based on at least one of a size of the 3D sub-image and a type of the subject included in the 3D radar image. In the detection step, the detection unit 18 detects an object in the 3D sub-image by using the selected learned model.

### <Configuration Example of Detection Apparatus 100>

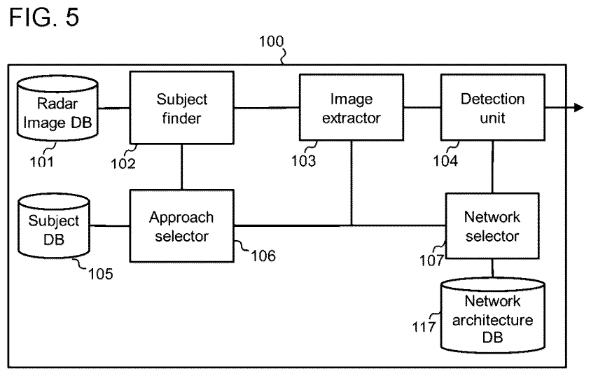

A configuration example of the detection apparatus 100 for radar images in accordance with the first example embodiment will be explained in detail with reference to block diagrams shown in FIG. 5.

As shown in FIG. 5, one of the configuration example of the detection apparatus 100 according to the first example embodiment can include a radar image DB storage 101, a subject finder 102, an image extractor 103, a detection unit 104, a subject DB storage 105, an approach selector 106, a network selector 107 and a network architecture DB storage 117.

The subject finder 102 functions as the position determination unit 12. The image extractor 103 functions as the extraction unit 14. The network selector 107 functions as the model selection unit 16. The detection unit 104 functions as the detection unit 18.

The radar image DB storage 101 may or may not be included in the detection apparatus 100. The subject DB storage 105 may or may not be included in the detection apparatus 100. The network architecture DB storage 117 may or may not be included in the detection apparatus 100.

In the example of this figure, the detection apparatus 100 further comprises an extraction size determination unit. The extraction size determination unit determines the one of extraction sizes to be used for extracting of the 3D sub-image based on subject information in which at least an extraction size is associated with each of a plurality of subject IDs and the subject ID of the subject included in the 3D radar image. The approach Selector 106 in FIG. 5 functions as the extraction size determination unit.

Next, the operation of the detection apparatus 100 will be explained. It is to be noted that this operation explains the prediction phase of the deep learning network, but same can be extended to learning phase without loss of generality: During its operation, it is assumed that the 3D radar images are measured as explained, stored in the radar image DB storage 101 and read one by one from there. The 3D radar images are then sent to subject finder 102. The subject finder 102 localizes the subject (can be single or multiple) and passes the subject position along with the 3D radar image to the image extractor 103. The subject finder 102 receives means to find the subject(s) from the approach selector 106. The approach selector 106 also outputs to the image extractor 103 the extracted image size(s) (extraction size(s)). The image extractor 103 extracts the 3D sub-image of size(s) outputted by approach selector 106 using the subject position information and passes it to the detection unit 104. The detection unit 104 can use a deep learning module for detection of the object. The approach selector 106 also passes the extracted image size to a network selector 107 which chooses the appropriate deep learning network architecture from a DB based on extracted image size and/or subject ID. The selected network architecture is given as input to the detection unit 104, which also receives the extracted image(s) (3D sub-image(s)) of smaller size to detect the object. The detection unit 104 inputs the 3D sub-image to the network architecture (the learned model) and obtains predicted results as the output of the network architecture (the learned model). The output of the detection unit 104 informs about the object's presence/absence information (and in some cases position as well).

The detection unit 18 may output at least one of information indicating whether the object exists or not, a class of the detected object, and position information of the object. In this configuration, the expected output from the detection unit 104 is presence/absence information about the object-of-interest (henceforth referred to as the ‘object’), and this object may be a part of but need not be same as the subject. The presence/absence information of the object can be in the form of image-level class (classifier) or pixel-level class (segmentation). In addition, position of the object may also be given as output.

The radar image DB storage 101 provides radar images. The radar image DB storage 101 contains the measured and generated 3D radar images. It serves as the data source by providing the 3D radar image as input to the subject finder 102.

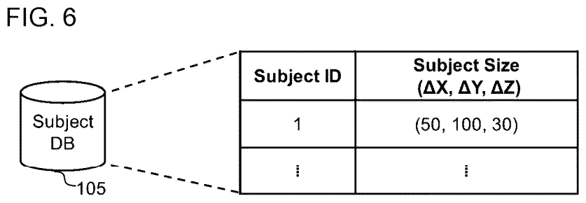

In the subject DB storage 105, a plurality of subject sizes are stored in advance. Each size is associated with a subject ID. In present configuration example, the subject DB storage 105 stores various subject's information (size, etc.), linked with the subject's ID in a tabular format. The subject DB storage 105 can be probed for subject's information using the ID as primary key. One example of subject's information is the size of the subject as shown in example table of subject DB in FIG. 6. Here, the subject size in the subject DB is the size of the subject assumed in the 3D radar image.

Also, in the subject DB storage 105, a plurality of means to find the subject position(s) are stored in advance. Each means to find the subject position(s) is associated with a subject ID. In present configuration example, the approach selector 106 decides an approach to find subject's position based on subject's information probed from subject DB storage 105. The approach selector 106 outputs the means to find the subject position(s) to the subject finder 102. The approach selector 106 also outputs the extracted image size(s) and subject IDs to the image extractor 103 and the network selector 107 based on said subject's information. The means to find the subject position(s) depends on the design of the subject finder 102, some example of the means can include the projection axis, position axis (the axis along which position is to be found), etc. Few example configurations of the approach selector 106 will be explained with the example configurations of the subject finder 102.

When the 3D radar image is stored in the radar image DB storage 101 in the state associated with a subject ID, the approach selector 106 acquires the subject ID of the 3D radar image to be processed. The approach selector 106 read the subject size and the means to find the subject position(s) to be applied the 3D radar image from the subject DB storage 105 based on the acquired subject ID.

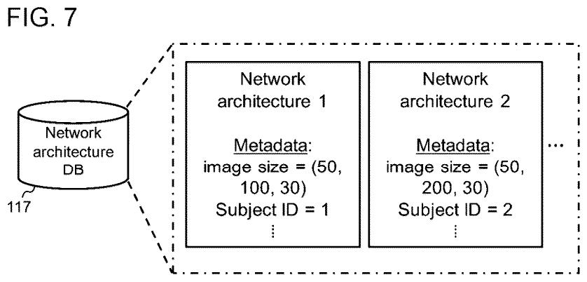

In the network architecture DB storage 117, a plurality of learned models are stored in advance. Each learned model is associated with at least one of size of the 3D sub-image and a subject ID. In present configuration example, the network architecture DB storage 117 provides architectures (for various image sizes, subject types, etc.). The network architecture DB storage 117 contains various trained network architectures for various image sizes, subject types, or the like. The network architectures are pre-trained for classification, object detection and/or segmentation task, distinguishable by input image sizes and/or subject IDs. The network architecture DB storage 117 can be probed for network architecture by using the metadata e.g. extracted image size(s) and/or subject IDs. An example configuration of the network architecture DB stored in network architecture DB storage 117 is shown in FIG. 7 where the different network architectures are distinguishable by their metadata information.

The network selector 107 selects network architecture for the detection unit 104 based on the extracted image size(s) and/or subject ID(s) received from the approach selector 106. The network architectures are selected from the network architecture DB storage 117 using the extracted image size(s) and/or the subject ID as search key. The network selector 107 outputs the network architecture(s) to the detection unit 104.

It is understanding that using the network architecture for a different image size that what it is trained for leads to degradation of performance. Here, it is assumed that the images are given as input to the network architecture without resizing, for aforementioned processing time and performance related reasons. Hence depending on the change in extracted image size, the input image size to the network architecture will change and subsequently network architecture has to be changed. Moreover in case there are different types of subject, then a dedicated network architecture is needed to detect object for each subject type. The given reasons signify the need for the network selector 107.

The detection unit 104 obtains presence/absence information of object in radar image based on the selected network architecture from network selector 107 and the extracted 3D sub-image(s) from the image extractor 103. The detection unit 104 outputs the presence/absence information of the object. As mentioned, the object may be part of but not same as the said subject. Also, it is to be noted that the said deep learning module can be a classifier (outputs a single/multiple class for each image), object detector (outputs class and position of object per image) or a segmentation network (outputs a pixel level class map same size as input image). The detection unit 104 can output the object's presence/absence information in the form of image-level class (classification) or pixel-level class (segmentation). It can also output position of object in addition to the presence/absence information.

The image extractor 103 extract the subject's 3D radar image based on the subject position(s) received from the subject finder 102 and extracted image size(s) received from approach selector 106. The image extractor 103 received the original 3D radar image from subject finder 102 on which extraction is performed. The image extractor 103 extracts the image(s) from original 3D radar image using the received subject position(s). The image extractor 103 outputs the extracted image(s) (i.e. the 3D sub-image(s)) to the detection unit 104. The said subject position(s) may indicate the center position of the subject(s) or any of the corners, for example. The extracted 3D sub-image may be a simply cropped image of the portion of the 3D radar image. Each 3D sub-image includes only a part of the subject or whole of the subject. The image extractor 103 may generate a plurality of 3D sub-image from one 3D radar image. The extracted 3D sub-image and the 3D radar image have the same quality, resolution and so on. The cutting position in the 3D radar image is determined based on the subject position received from the subject finder 102. The size of the 3D sub-image is determined based on the extraction sizes received from approach selector 106.

The subject finder 102 finds the subject position(s) in the 3D radar image based on the means to find subject(s) received from the approach selector 106 and original 3D radar image read from the radar image DB storage 101. The subject finder 102 outputs the subject position(s) to the image extractor 103. The subject finder 102 also outputs the original radar image to the image extractor 103.

### <Configuration of Subject Finder 102>

Next, the details of the subject finder 102 and the approach selector 106 will made clear with the help of few example configurations.

### <<First Example of Subject Finder 102>>

In the present example, the extraction size used for extracting of the 3D sub-image is a subject extraction size for extracting the whole of the subject. The reference position indicates a position of the subject.

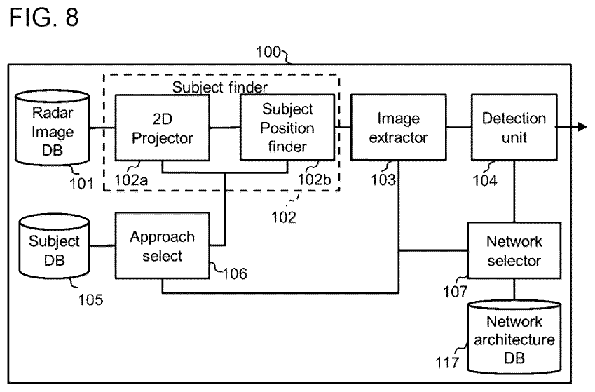

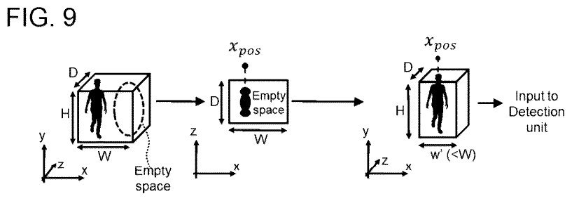

The first example configuration of the subject finder 102 is explained with reference to FIG. 8, where the subject finder 102 consists of two sub-blocks: a 2D projector 102a and a subject position finder 102b. The technique is explained assuming single subject but same can be extended to multiple subjects. In this example, firstly the 2D image is generated through projection and it is processed to find subject position. The 2D Projector 102a outputs the projected 2D image to the subject position finder 102b based on the projection axis from approach selector 106 (said means to find the subject). The 2D image is generated by projecting the 3D image along the said projection axis. The projection can be max-projection or energy projection or some other. The subject position finder 102b outputs the position of the subject in the 2D image based on the 2D projected image from the 2D Projector 102a and the axes along which the position is to be found from the approach selector 106 (said means to find the subject). The position can be found in many ways, e.g. find the point of maximum intensity: The position of the subject is given as output from the subject finder 102 to the image extractor 103. The whole example operation to obtain extracted radar image from whole radar image is explained graphically in FIG. 9.

### <<Second Example of Subject Finder 102>>

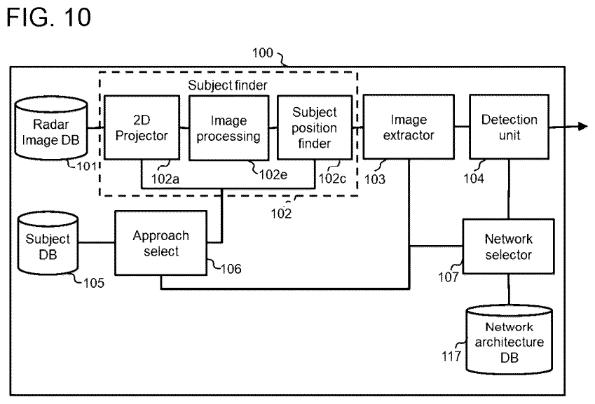

The subject finder 102 can sometimes consist of an image processing unit 102e which outputs the processed 2D image based on some image processing algorithms e.g. filtering, sharpening, etc. The purpose of the image processing unit 102e is to assist the subject position finder block's operations e.g. clustering, peak finding. It is shown in FIG. 10.

### <<Third Example of Subject Finder 102>>

In the present example, the extraction sizes used for extracting of the 3D sub-image is a part extraction size for extracting only a part of the subject. Also, the reference position indicates a position of the part of the subject.

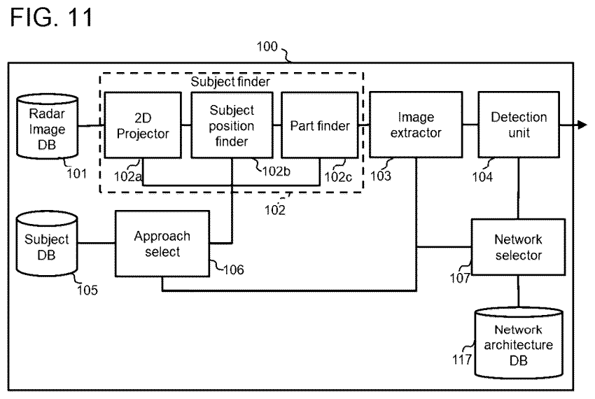

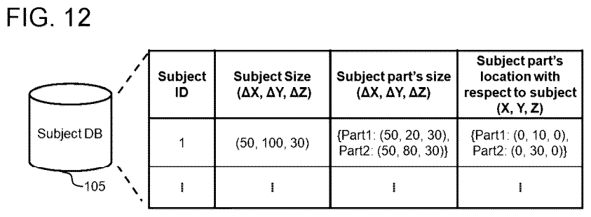

The present example configuration of the subject finder 102 is explained with reference to FIG. 11, which is a specialized case of the first example where the subject finder 102 is supposed to find (prior known) parts of the subject. Note the configurations of the 2D projector 102a and subject position finder 102b is same as those explained in first example (given above) and therefore explanations are not repeated. The additional block here is the part finder 102c outputs the position of the subject parts to the image extractor 103 based on the subject position received from the subject position finder 102b, and the subject part's relative position with respect to the subject received from approach selector 106. The part finder 102c can output the (global) positions of the subject parts if it has subject's (global) position information and part's relative position with respect to the subject by using simple coordinate mathematics. In this example configuration, in the subject DB storage 105, a plurality of combinations of the subject part's relative position and the subject part's size are stored in advance. Each combination is associated with a subject ID. The approach selector 106 additionally reads the subject part's relative position with respect to the subject and subject part's sizes from subject DB storage 105 using the subject ID. An example table configuration used in subject DB storage 105 is shown in FIG. 12.

In this example configuration, the image extractor outputs the extracted images (i.e. the 3D sub-images) of subject's parts to the detection unit 104 based on the subject part's position(s) received from the part finder 102c and extracted image sizes of each parts received from the approach selector 106. The approach selector 106 read the subject part's relative position and the subject part's size from the subject DB storage 105 based on the subject ID. The detection unit 104 additionally receives networks for each subject part (may be same or different) selected by the network selector 107. The detection unit 104 then outputs the presence/absence information of the object in the extracted image(s) by analyzing the subject part images individually.

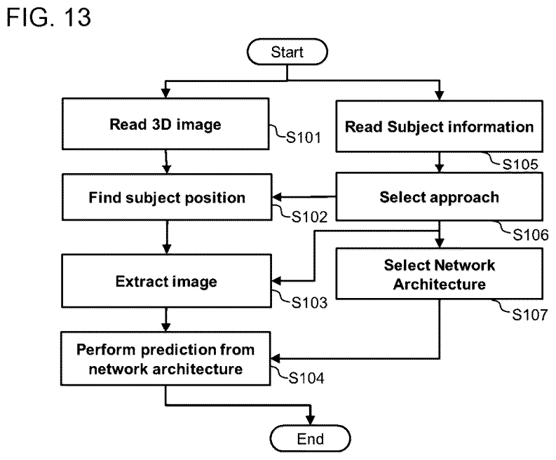

Next, an example of an operation performed by the detection apparatus 100 for radar images according to the first example embodiment in the operational mode will be explained with reference to a flowchart shown in FIG. 13. The subject information (size linked with a subject ID) is stored in the subject DB storage 105. Moreover, the various network architectures are pre-trained for different image sizes and stored in the network architecture DB storage 117.

At the start of the detection apparatus 100, the 3D radar image is read from the radar image DB storage 101 in step S101. The subject information is read from the subject DB storage 105 in step S105. Then approach is decided by the approach selector 106 i.e. what means are required to locate the subject and given as output to the image extractor 103 (step S106). The network architecture is selected by network selector 107 from the network architecture DB storage 117 and given as output to the detection unit 104 (step S107). The subject finder 102 finds and outputs the subject position(s) to the image extractor 103 (step S102). The image extractor 103 extracts the image(s) using the subject position(s) and extracted image size(s) and outputs extracted images to the detection unit 104 (step S103). The detection unit 104 predicts the presence/absence information of the object in the extracted 3D sub-image, may use classification or segmentation (step S104).

As described above, the detection apparatus 100 in accordance with the first example embodiment of the present disclosure extracts the image(s) of smaller size using the subject(s) position information. This reduces the processing time of the predicting the presence/absence information of the object in the learned model i.e. the detection unit and preferably enables desired real-time operation. It can be understood that the reduction in processing time in the learned model due to reduced image size is much larger compared to the slight increment in processing time due to the subject finder 102 (performs image processing operations).

### Second Example Embodiment

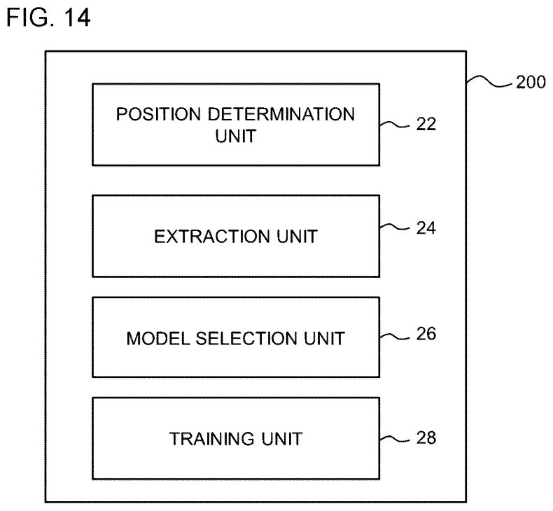

FIG. 14 illustrates an example diagram of a function-based configuration of the model generation apparatus 200 according to of the second example embodiment. The model generation apparatus 200 includes a position determination unit 22, an extraction unit 24, a model selection unit 26, and a training unit 28. The position determination unit 22 determines a position of a subject in a 3D radar image. The extraction unit 24 extracts a 3D sub-image from the 3D radar image by using a reference position based on the determined position of the subject and one of extraction sizes specified for each type of subject. The model selection unit 26 which selects at least a model based on at least one of a size of the 3D sub-image and a type of the subject included in the 3D radar image. The training unit 28 performs machine learning on the selected model by using a combination of the 3D sub-image and information indicating the position of the object in the 3D sub-image as training data. The following is a detailed explanation.

The position determination unit 22, the extraction unit 24, and the model selection unit 26 are same as the position determination unit 12, the extraction unit 14, and the model selection unit 16 according to the first example embodiment, respectively.

The model generation apparatus 200 can generate or update the learned models used by the detection apparatus 100 according to the first example embodiment. The learned model generated or updated by the model generation apparatus 200 may be stored in the network architecture DB storage 117 of the detection apparatus 100.

The model generation apparatus 200 may also serves as the detection apparatus 100 explained in the first example embodiment, too. That is, the detection apparatus 100 may include the annotation adjustor 209, and the detection unit 104 may function also as the training unit 204. In that case, the performance of the detection apparatus 100 may be evaluated by comparing the output of the learned model and the information indicating the position of the object in the 3D sub-image as correct answer data.

### <Example of Hardware Configuration>

In some embodiments, each functional unit included in model generation apparatus 200 may be implemented with at least one hardware component, and each hardware component may realize one or more of the functional units. In some embodiments, each functional unit may be implemented with at least one software component. In some embodiments, each functional unit may be implemented with a combination of hardware components and software components.

The model generation apparatus 200 may be implemented with a special purpose computer manufactured for implementing the model generation apparatus 200, or may be implemented with a commodity computer like a personal computer (PC), a server machine, or a mobile device.

The model generation apparatus 200 may be realized with the computer 1000 illustrated in FIG. 3. The storage device 1080 may store program modules, each of which is an implementation of a functional unit of the model generation apparatus 200. The CPU 1040 executes each program module, and thereby realizing each functional unit of the model generation apparatus 200.

### <Flow of Process>

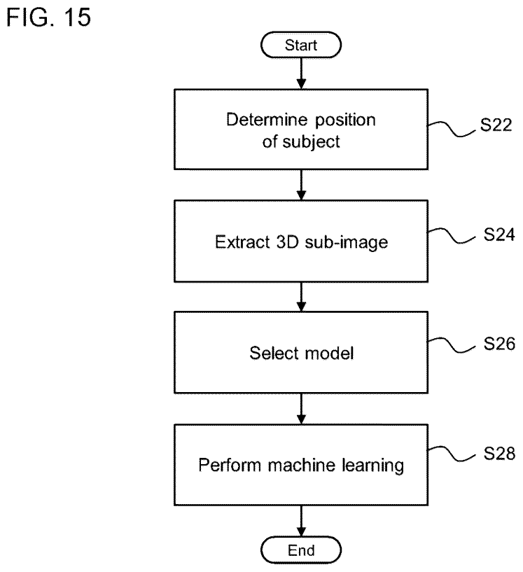

FIG. 15 is a flowchart that illustrates the process sequence performed by the model generation apparatus 200 of the second example embodiment.

The model generation method according to the second example embodiment is performed by a computer. The model generation method includes a position determination step (S22), an extraction step (S24), a model selection step (S26), and a training step (S28). In the position determination step, the position determination unit 22 determines a position of a subject in a 3D radar image. In the extraction step, the extraction unit 24 extracts a 3D sub-image from the 3D radar image by using a reference position based on the determined position of the subject and one of extraction sizes specified for each type of subject. In the model selection step, the model selection unit 26 selects at least a model based on at least one of a size of the 3D sub-image and a type of the subject included in the 3D radar image. In the training step, the training unit 28 performs machine learning on the selected model by using a combination of the 3D sub-image and information indicating the position of the object in the 3D sub-image as training data.

### <Configuration Example of Model Generation Apparatus 200>

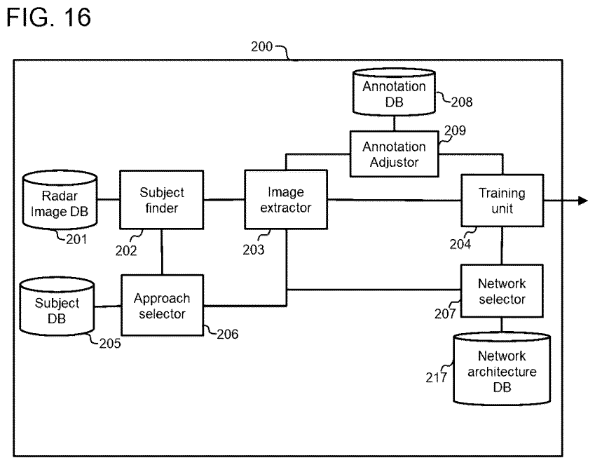

A configuration example of the model generation apparatus 200 in accordance with the second example embodiment will be explained in detail with reference to block diagrams shown in FIG. 16.

As shown in FIG. 16, one of the configuration of the model generation apparatus 200, according to the second example embodiment, can include a radar image DB storage 201, a subject finder 202, an image extractor 203, an annotation DB storage 208, an annotation adjustor 209, a training unit 204, a subject DB storage 205, an approach selector 206, a network selector 207 and a network architecture DB storage 217. The annotation DB storage 208 may or may not be included in the model generation apparatus 200. Note the configurations and functions of the radar image DB storage 201, the subject finder 202, the Subject DB storage 205, the approach selector 206, and the network selector 207 are same as those of the radar image DB storage 101, the subject finder 102, the Subject DB storage 105, the approach selector 106, and the network selector 107 according to the first example embodiment, respectively. Therefore, explanations are not repeated. Also, the image extractor 203 is same as the image extractor 103 according to the first example embodiment except for the points explained below.

The subject finder 202 functions as the position determination unit 22. The image extractor 203 functions as the extraction unit 24. The network selector 207 functions as the model selection unit 26. The training unit 204 functions as the training unit 28.

A configuration of the model generation apparatus 200 in accordance with the second example embodiment will be explained with reference to block diagrams shown in FIG. 16. In this configuration also, it is assumed that the subject identity is known to the subject finder 202 as prior information. The expected output can be the position of the object in addition to the presence/absence information. This said object may be a part of but need not be same as the subject. The presence/absence and position information of the object can be in the form of image-level class (classification) and bounding box (object detection).

This particular embodiment aims at a scenario where the ground truth object position is known in advance and the objective is to evaluate the performance of the detection apparatus 100 (prediction phase) or to improve the performance of the detection apparatus 100 (training phase) or both (online prediction and training). The information indicating the position of the object in the 3D sub-image (correct answer data) is obtained by using the ground truth object position as described later.

The object's ground truth position and presence/absence information collectively are referred as annotation. Since the subject's position in the extracted image and also the extracted image size changes, so it is necessary to adjust the object's position information as well. The purpose of the second example embodiment is to adjust the object's position (henceforth referred to as annotation adjustment) in accordance with the subject's position in the extracted image.

The annotation DB storage 208 contains the annotation information of all radar images contained in the radar image storage 201 distinguishable by the name of the radar image. The position of the subject is identified by another method and the annotation information is prepared in advance.

The annotation adjustor 209 outputs the adjusted annotation to the training unit 204 based on received subject position(s) and extracted image size(s) from the image extractor 203. The ground truth annotation information is read from the annotation DB storage 208. The annotation adjustor 209 also receives the original radar image size as part of annotation information to assist in the annotation adjustment. In the example case the ground truth position is specified by rectangular bounding box with respect to the original radar image. Then adjustment may mean shifting bounding box's center based on subject's position and adjust their size based on extracted and original image size.

The network architecture DB storage 217 contains various trained or untrained network architectures, for classification and/or object detection, distinguishable by different input image sizes and/or subject IDs. The said architectures may or may not be pre-trained depending on the task at hand e.g. training, performance evaluation. The network selector 207 utilizes the network architecture DB storage 217 to select network architecture as explained for the network selector 107 in the first example embodiment of present disclosure.

The training unit 204 acquires the selected network architecture including a model from the network selector 207. The model including neural network. The training unit 204 input the 3D sub-image acquired from the image extractor 203 to the network architecture (the model). The training unit 204 may output the position of the object in addition to the presence/absence information based on selected network architecture from the network selector 207 and the extracted image(s) from the image extractor 203. In addition, the training unit 204 also receives the adjusted annotation information from the annotation adjustor 209 which it can use for update of architecture parameters (training) or performance evaluation of the architecture or both. In the training, the combination of the 3D sub-image and the adjusted annotation information is used as training data. The training unit 204 may output the object's presence/absence and position information in the form of image-level class (classification) and bounding box (object detection).

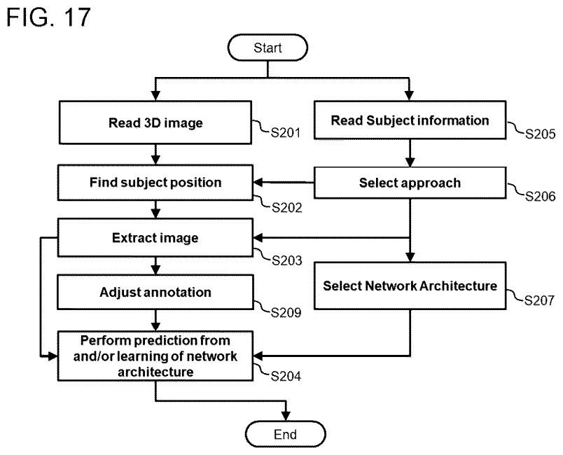

Next, an example of an operation performed by the model generation apparatus 200 according to the second example embodiment in the operational mode will be explained with reference to a flowchart shown in FIG. 17. The subject information (size linked with ID) is stored in the subject DB storage 205. Moreover, the various network architectures for different image sizes are stored in network architecture DB storage 217. Note that steps S201, S202, S205, S206 and S207 are same as the steps S101, S102, S105, S106 and S107 as explained in the first example embodiment of the present disclosure and therefore their explanations are not repeated.

The image extractor 203 extracts the image(s) using the subject position(s) and extracted image size(s) and outputs to the training unit 204, in addition the image extractor 203 outputs the subject position(s) and extracted image size(s) to the annotation adjustor 209 (step S203). The annotation adjustor 209 reads the annotation prepared for the processing 3D radar image from annotation DB storage 208 and adjusts the annotation using the input subject position(s) and extracted image size(s), the annotation adjustor 209 then outputs the adjusted annotation to the training unit 204 (step S209). The training unit 204 receives the extracted image(s) from the image extractor 203 and predicts the object's presence/absence information and its position (may use classification/object detection) and outputs the same (step S204).

As described above, the model generation apparatus 200 in accordance with the second example embodiment of the present disclosure extracts the image(s) of smaller size using the subject(s) position information. This reduces the processing time of the obtaining the presence/absence and position information of the object and preferably enables desired real-time operation. In addition, performance evaluation and/or update of the learner preferably in real-time is possible due to the annotation adjustment function.

### Third Example Embodiment

The detection apparatus 100 of the third example embodiment is the same as the detection apparatus 100 of the first example embodiment except for the points explained below:

The detection apparatus 100 of the third example embodiment further includes a subject ID determination unit that determines the subject ID to be used for determining the one of extraction sizes by identifying the type of the subject included in the 3D radar image. The following is a detailed explanation.

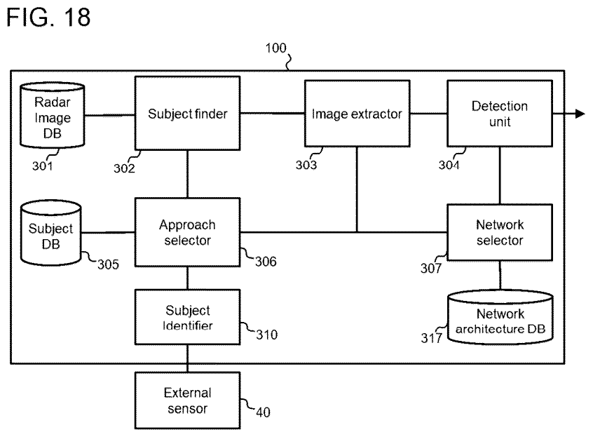

A configuration example of the detection apparatus 100 for radar images in accordance with the third example embodiment of the present disclosure will be explained with reference to block diagrams shown in FIG. 18. In contrast to the previous configuration, in this configuration it is not assumed that the subject identity is known to the subject finder as prior information but the subject identity can be obtained as a real-time information. Finding the subject identity during run-time is more practical since it may not always be possible to know the subject identity in advance in a real-time operation setup. The expected output, similar to the first example embodiment, is the presence/absence information of the object. This said object may be a part of but need not be same as the subject. The presence/absence of the object can be in the form of image-level class (classification) or pixel-level class (segmentation). In the present example embodiment, the 3D radar image stored in the radar image DB 301 may not be associated with a subject ID.

As shown in FIG. 18, one of the configuration of the detection apparatus 100 according to the third example embodiment, can include a radar image DB storage 301, a subject finder 302, an image extractor 303, a detection unit 304, a subject DB storage 305, an approach selector 306, a subject identifier (subject ID determination unit) 310, a network selector 307 and a network architecture DB storage 317. Note the configurations and functions of the radar image DB storage 301, the subject finder 302, image extractor 303, the detection unit 304, the subject DB storage 305, the approach selector 306, the network selector 307, and the network architecture DB storage 317 are same as those of the radar image DB storage 101, the subject finder 102, image extractor 103, the detection unit 104, the subject DB storage 105, the approach selector 106, and the network selector 107 and the network architecture DB storage 117 according to the first example embodiment, respectively. Therefore, explanations are not repeated.

The subject finder 302 may acquire the measured scattered radar signal from the radar 92. The 3D radar image may be generated in the detection apparatus 100 instead of acquired from the radar image DB storage 301.

The subject identifier 310 outputs the subject identity, for example subject ID, to the approach selector 306. The subject identifier 310 may be connected to an external sensor 40 to obtain additional information which is used to identify the subject. The subject is one included in the 3D radar image read to be processed from the radar image DB storage 301. In one of the example configurations, the subject identifier 310 receives captured optical image from an optical camera. The external sensor 40 may be the camera 98. The subject identifier 310 may use object detection means (amongst other means) to identify the subject.

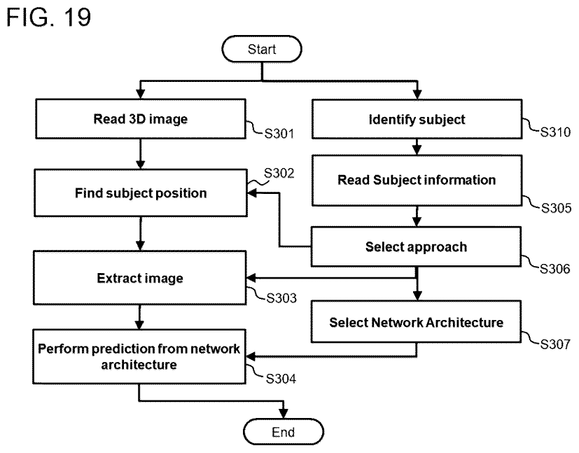

Next, an example of an operation performed by the detection apparatus 100 for radar images according to the third example embodiment in the operational mode will be explained with reference to a flowchart shown in FIG. 19. The subject information (size linked with ID) is stored in the subject DB storage 305. Moreover, the various network architectures for different image sizes are stored in the network architecture DB storage 317. Note that steps S301, S302, S303, S304, S305, S306 and S307 are same as the steps S101, S102, S103, S104, S105, S106 and S107 as explained in the first example embodiment of the present disclosure and therefore their explanations are not repeated.

The subject identifier 310 identifies the subject and outputs its identity to the approach selector 306, this step may or may not use an external sensor information (step S310).

It is to be noted that the model generation apparatus 200 as described in the second example embodiment may include the subject identifier 310 described above. In that case, the 3D radar image stored in the radar image DB 201 may not be associated with a subject ID.

As described above, the detection apparatus 100 in accordance with the third example embodiment of the present disclosure extracts the image(s) of smaller size using the subject(s) position information. This reduces the processing time of the obtaining the presence/absence and position information of the object and preferably enables desired real-time operation. In addition, there is flexibility to identify the subject preferably in real-time instead of assuming that the subject identity is known in advance.

The whole or part of the example embodiments disclosed above can be described as, but not limited to, the following supplementary notes.

1-1. A detection apparatus comprising:
a position determination unit that determines a position of a subject in a 3D radar image;
an extraction unit that extracts a 3D sub-image from the 3D radar image by using a reference position based on the determined position of the subject and one of extraction sizes specified for each type of subject;
a model selection unit that selects at least a learned model based on at least one of a size of the 3D sub-image and a type of the subject included in the 3D radar image; and
a detection unit that detects an object in the 3D sub-image by using the selected learned model.

1-2. The detection apparatus according to 1-1., further comprising an extraction size determination unit that determines the one of extraction sizes to be used for extracting of the 3D sub-image based on subject information in which at least an extraction size is associated with each of a plurality of subject IDs and the subject ID of the subject included in the 3D radar image.

1-3. The detection apparatus according to 1-2., further comprising a subject ID determination unit that determines the subject ID to be used for determining the one of extraction sizes by identifying the type of the subject included in the 3D radar image.

1-4. The detection apparatus according to any one of 1-1. to 1-3., wherein
the one of extraction sizes used for extracting of the 3D sub-image is a subject extraction size for extracting the whole of the subject.

1-5. The detection apparatus according to any one of 1-1. to 1-3., wherein
the one of extraction sizes used for extracting of the 3D sub-image is a part extraction size for extracting only a part of the subject, and
the reference position indicates a position of the part of the subject.

1-6. The detection apparatus according to any one of 1-1. to 1-5., wherein the detection unit outputs at least one of information indicating whether the object exists or not, a class of the detected object, and position information of the object.

2-1. A model generation apparatus comprising:
a position determination unit which determines a position of a subject in a 3D radar image;
an extraction unit which extracts a 3D sub-image from the 3D radar image by using a reference position based on the determined position of the subject and one of extraction sizes specified for each type of subject;
a model selection unit which selects at least a model based on at least one of a size of the 3D sub-image and a type of the subject included in the 3D radar image; and
a training unit which performs machine learning on the selected model by using a combination of the 3D sub-image and information indicating a position of the object in the 3D sub-image as training data.

2-2. The model generation apparatus according to 2-1., further comprising an extraction size determination unit that determines the one of extraction sizes to be used for extracting of the 3D sub-image based on subject information in which at least an extraction size is associated with each of a plurality of subject IDs and the subject ID of the subject included in the 3D radar image.

2-3. The model generation apparatus according to 2-2., further comprising a subject ID determination unit that determines the subject ID to be used for determining the one of extraction sizes by identifying the type of the subject included in the 3D radar image.

2-4. The model generation apparatus according to any one of 2-1. to 2-3., wherein
the one of extraction sizes used for extracting of the 3D sub-image is a subject extraction size for extracting the whole of the subject.

2-5. The detection apparatus according to any one of 2-1. to 2-3., wherein
the one of extraction sizes used for extracting of the 3D sub-image is a part extraction size for extracting only a part of the subject, and
the reference position indicates a position of the part of the subject.

3-1. A detection method, performed by a computer, comprising:
determining a position of a subject in a 3D radar image;
extracting a 3D sub-image from the 3D radar image by using a reference position based on the determined position of the subject and one of extraction sizes specified for each type of subject;
selecting at least a learned model based on at least one of a size of the 3D sub-image and a type of the subject included in the 3D radar image; and
detecting an object in the 3D sub-image by using the selected learned model.

3-2. The detection method according to 3-1., further comprising determining the one of extraction sizes to be used for extracting of the 3D sub-image based on a subject information in which at least an extraction size is associated with each of a plurality of subject IDs and the subject ID of the subject included in the 3D radar image.

3-3. The detection method according to 3-2., further comprising determining the subject ID to be used for determining the one of extraction sizes by identifying the type of the subject included in the 3D radar image.

3-4. The detection method according to any one of 3-1. to 3-3., wherein
the one of extraction sizes used for extracting of the 3D sub-image is a subject extraction size for extracting the whole of the subject.

3-5. The detection method according to any one of 3-1. to 3-3., wherein
the one of extraction sizes used for extracting of the 3D sub-image is a part extraction size for extracting only a part of the subject, and
the reference position indicates a position of the part of the subject.

3-6. The detection method according to any one of 3-1. to 3-5., further comprising outputting at least one of information indicating whether the object exists or not, a class of the detected object, and position information of the object.

4-1. A program causing a computer to execute a detection method, the detection method comprising:
determining a position of a subject in a 3D radar image;
extracting a 3D sub-image from the 3D radar image by using a reference position based on the determined position of the subject and one of extraction sizes specified for each type of subject;
selecting at least a learned model based on at least one of a size of the 3D sub-image and a type of the subject included in the 3D radar image; and
detecting an object in the 3D sub-image by using the selected learned model.

4-2. The program according to 4-1., wherein the detection method further comprises determining the one of extraction sizes to be used for extracting of the 3D sub-image based on subject information in which at least an extraction size is associated with each of a plurality of subject IDs and the subject ID of the subject included in the 3D radar image.

4-3. The program according to 4-2., wherein the detection method further comprises determining the subject ID to be used for determining the one of extraction sizes by identifying the type of the subject included in the 3D radar image.

4-4. The program according to any one of 4-1. to 4-3., wherein
the one of extraction sizes used for extracting of the 3D sub-image is a subject extraction size for extracting a whole the subject.

4-5. The program according to any one of 4-1. to 4-3., wherein
the one of extraction sizes used for extracting of the 3D sub-image is a part extraction size for extracting only a part of the subject, and
the reference position indicates a position of the part of the subject.

4-6. The program according to any one of 4-1. to 4-5., wherein the detection method further comprises outputting at least one of information indicating whether the object exists or not, a class of the detected object, and position information of the object.

### REFERENCE SIGNS LIST

100 Detection apparatus
200 Model generation apparatus
12 Position determination unit
14 Extraction unit
16 Model selection unit
18 Detection unit
101, 201, 301 Radar image DB storage
102, 202, 302 Subject finder
103, 203, 303 Image extractor
104, 304 Detection unit
22 Position determination unit
24 Extraction unit
26 Model selection unit
28 Training unit
204 Training unit
105, 205, 305 Subject DB storage
106, 206, 306 Approach selector
107, 207, 307 Network selector
117, 217,317 Network architecture DB storage
209 Annotation adjustor
208 Annotation DB storage
310 Subject identifier

What is claimed is:

1. A detection apparatus comprising:
at least one memory configured to store instructions; and
at least one processor configured to execute the instructions to perform operations comprising:
determining a position of a subject in a 3D radar image;
extracting a 3D sub-image from the 3D radar image by using a reference position based on the determined position of the subject and one of extraction sizes specified for each type of subject;
selecting at least a learned model based on at least one of a size of the 3D sub-image and a type of the subject included in the 3D radar image; and
detecting an object in the 3D sub-image by using the selected learned model.

2. The detection apparatus according to claim 1, wherein the operations further comprise determining the one of extraction sizes to be used for extracting of the 3D sub-image based on subject information in which at least an extraction size is associated with each of a plurality of subject IDs and the subject ID of the subject included in the 3D radar image.

3. The detection apparatus according to claim 2, wherein the operations further comprise determining the subject ID to be used for determining the one of extraction sizes by identifying the type of the subject included in the 3D radar image.

4. The detection apparatus according to claim 1, wherein
the one of extraction sizes used for extracting of the 3D sub-image is a subject extraction size for extracting the whole of the subject.

5. The detection apparatus according to claim 1, wherein
the one of extraction sizes used for extracting of the 3D sub-image is a part extraction size for extracting only a part of the subject, and
the reference position indicates a position of the part of the subject.

6. The detection apparatus according to claim 1, wherein the operations further comprise outputting at least one of information indicating whether the object exists or not, a class of the detected object, and position information of the object.

7-11. (canceled)

12. A detection method, performed by a computer, comprising:
determining a position of a subject in a 3D radar image;
extracting a 3D sub-image from the 3D radar image by using a reference position based on the determined position of the subject and one of extraction sizes specified for each type of subject;
selecting at least a learned model based on at least one of a size of the 3D sub-image and a type of the subject included in the 3D radar image; and
detecting an object in the 3D sub-image by using the selected learned model.

13. The detection method according to claim 12, further comprising determining the one of extraction sizes to be used for extracting of the 3D sub-image based on a subject information in which at least an extraction size is associated with each of a plurality of subject IDs and the subject ID of the subject included in the 3D radar image.

14. The detection method according to claim 13, further comprising determining the subject ID to be used for determining the one of extraction sizes by identifying the type of the subject included in the 3D radar image.

15. The detection method according to claim 12, wherein
the one of extraction sizes used for extracting of the 3D sub-image is a subject extraction size for extracting the whole of the subject.

16. The detection method according to claim 12, wherein
the one of extraction sizes used for extracting of the 3D sub-image is a part extraction size for extracting only a part of the subject, and
the reference position indicates a position of the part of the subject.

17. The detection method according to claim 12, further comprising outputting at least one of information indicating whether the object exists or not, a class of the detected object, and position information of the object.

18. A non-transitory storage medium storing a program causing a computer to execute a detection method, the detection method comprising:
determining a position of a subject in a 3D radar image;
extracting a 3D sub-image from the 3D radar image by using a reference position based on the determined position of the subject and one of extraction sizes specified for each type of subject;
selecting at least a learned model based on at least one of a size of the 3D sub-image and a type of the subject included in the 3D radar image; and
detecting an object in the 3D sub-image by using the selected learned model.

19. The non-transitory storage medium according to claim 18, wherein the detection method further comprises determining the one of extraction sizes to be used for extracting of the 3D sub-image based on subject information in which at least an extraction size is associated with each of a plurality of subject IDs and the subject ID of the subject included in the 3D radar image.

20. The non-transitory storage medium according to claim 19, wherein the detection method further comprises determining the subject ID to be used for determining the one of extraction sizes by identifying the type of the subject included in the 3D radar image.

21. The non-transitory storage medium according to claim 18, wherein
the one of extraction sizes used for extracting of the 3D sub-image is a subject extraction size for extracting a whole the subject.

22. The non-transitory storage medium according to claim 18, wherein
the one of extraction sizes used for extracting of the 3D sub-image is a part extraction size for extracting only a part of the subject, and
the reference position indicates a position of the part of the subject.

23. The non-transitory storage medium according to claim 18, wherein the detection method further comprises outputting at least one of information indicating whether the object exists or not, a class of the detected object, and position information of the object.
